(19) United States
(12) Patent Application Publication
(10) Pub. No.: US 2012/0133843 A1
(43) Pub. Date: May 31, 2012

(54) ELECTRONIC APPARATUS AND ELECTRONIC SYSTEM

(75) Inventors: Takafumi SAKAMOTO, Tokyo (JP); Tetsuro Itakura, Tokyo (JP)

(73) Assignee: KABUSHIKI KAISHA TOSHIBA, Minato-ku (JP)

(21) Appl. No.: 13/367,734

(22) Filed: Feb. 7, 2012

Related U.S. Application Data
(63) Continuation of application No. PCT/JP2009/064135, filed on Aug. 10, 2009.

(51) Int. Cl. H04N 5/44

(52) U.S. Cl. 348/734; 348/E05.096

(57) ABSTRACT

According to an embodiment, there is provided an electronic apparatus which operates under another electronic apparatus when the other electronic apparatus is controlled by a predetermined control instruction, including: a receiving unit, a switch, a microcomputer, and a power control unit. The receiving unit receives a power ON command. The microcomputer operates under control of the other electronic apparatus. The switch switches whether to supply external power to the microcomputer. The power control unit turns on the switch when the receiving unit receives the power ON command so that the microcomputer can be controlled by the other electronic apparatus.

### CROSS REFERENCE TO RELATED APPLICATIONS

This application is a continuation of International Application No. PCT/JP2009/064135, filed on Aug. 10, 2009, the entire contents of which is hereby incorporated by reference.

### FIELD

Embodiments relate to electronic an apparatus such as audio-visual equipment, and to an electronic system.

### BACKGROUND

JP-A 2006-319863 (Kokai) discloses a technique for minimizing the standby power consumption by providing a rectifier or the like in the remote control receiving unit of a television set or the like, and controlling a switch with power generated from the rectifier so as to switch on and off current from an external power source to an internal circuit in the television set.

Meanwhile, video equipment compliant with HDMI-CEC (High Definition Multimedia Interface-Consumer Electronics Control) have been put into practical use in recent years. Between such video equipment, coordinated operations can be performed, and one of such coordinated operations is a function called “one-touch play.”

The one-touch play function realizes the following operations. When a user presses a play button of a DVD player, for example, the DVD player automatically switches on a television set connected to the DVD player by HDMI, if the television set is in a standby state. The input of the television set is then automatically switched to the DVD player.

In a case where power is not supplied to a television set from an external power source, however, an operation coordinated with a DVD player, such as the one-touch play function, cannot be performed. That is, even if a user operates a DVD player or the like with a remote controller, the television set cannot be automatically switched on. This is because the television set cannot receive HDMI-CEC commands transmitted from the DVD player or the like, since power is not supplied to the television set. Therefore, the user needs to switch on the television set with a remote controller, and switch the input of the television set to the DVD player. This results in poor user-friendliness.

### BRIEF DESCRIPTION OF THE DRAWINGS

FIG. 1 is a block diagram showing an example structure of an electronic system including an electronic apparatus according to a first embodiment;

FIG. 2 is a flow diagram showing an example operation sequence according to the first embodiment;

FIG. 3 is a flow diagram showing another example operation sequence according to the first embodiment;

FIG. 4 is a block diagram showing an example structure of an electronic system including an electronic apparatus according to a second embodiment;

FIG. 5 is a flow diagram showing an example operation sequence according to the second embodiment;

FIG. 6 is a block diagram showing an example structure of an electronic system including an electronic apparatus according to a third embodiment;

FIG. 7 is a flow diagram showing an example operation sequence according to the third embodiment;

FIG. 8 is a flow diagram showing another example operation sequence according to the third embodiment;

FIG. 9 is a flow diagram showing yet another example operation sequence according to the third embodiment;

FIG. 10 is a block diagram showing an example structure of an electronic system including an electronic apparatus according to a fourth embodiment;

FIG. 11 is a flow diagram showing an example operation sequence according to the fourth embodiment;

FIG. 12 is a block diagram showing an example structure of an electronic system including an electronic apparatus according to a fifth embodiment;

FIG. 13 is a flow diagram showing an example sequence according to the fifth embodiment; and

FIG. 14 is a flow diagram showing another example sequence according to the fifth embodiment.

### DETAILED DESCRIPTION

According to an embodiment, there is provided an electronic apparatus which operates under another electronic apparatus when the other electronic apparatus is controlled by a predetermined control instruction, including: a receiving unit, a switch, a microcomputer, and a power control unit.

The receiving unit receives a power ON command.

The microcomputer operates under control of the other electronic apparatus.

The switch switches whether to supply external power to the microcomputer.

The power control unit turns on the switch when the receiving unit receives the power ON command so that the microcomputer can be controlled by the other electronic apparatus.

Hereinafter, embodiments will be described with reference to the accompanying drawings.

### First Embodiment

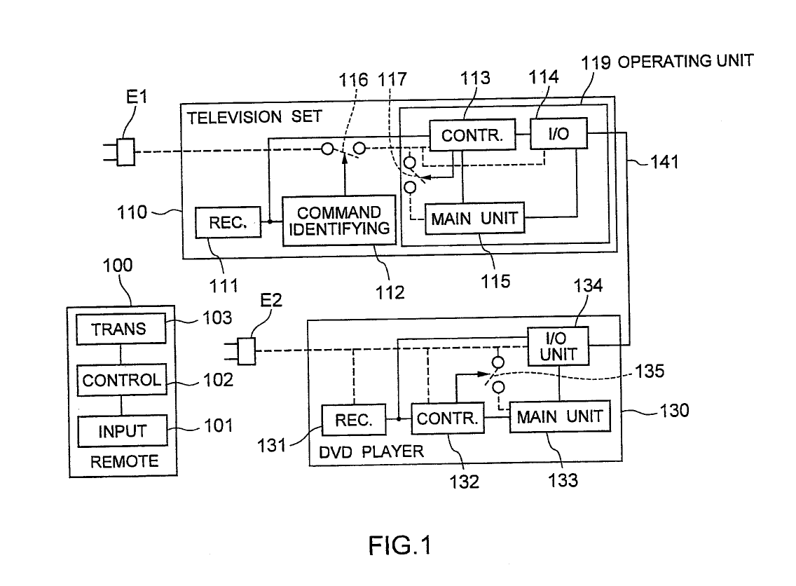

FIG. 1 shows an example of the entire structure of an electronic system according to a first embodiment that includes an electronic apparatus, another electronic apparatus, and a remote control device. Here, a television set 110 is shown as the electronic apparatus, a DVD player 130 is shown as the other electronic apparatus, and a remote controller 100 is shown as the remote control device.

The remote controller 100 is designed to perform a desired operation (a control instruction) mainly on the DVD player 130 by a user pressing a button or the like. The remote controller 100 includes: an input unit 101 that provides an interface for the user to perform the operation; a control unit 102 that generates a remote control command, based on the operation performed on the input unit 101 by the user; and a transmitting unit 103 that transmits the remote control command wirelessly or with infrared rays, based on an instruction from the control unit 102.

A receiving unit 111 in the television set 110 is designed to be capable of receiving the remote control command transmitted wirelessly or with infrared rays from the remote controller 100. A rectifier or the like is used as the receiving unit 111, so that the standby power consumption is minimized, and receptions can be performed with a low power consumption. The receiving unit 111 transmits the received remote control command to a power-supply command identifying unit 112 and a control unit 113.

The power-supply command identifying unit (a power-supply control unit) 112 determines whether the power-supply remote control command received at the receiving unit 111 is a power ON command (a power ON command for the DVD player or a power ON command for the television set). The power ON command for the DVD player is set beforehand in the television set 110 so that the DVD power-supply command can be identified by the power-supply command identifying unit 112. When the received remote control command is a power ON command, the power-supply command identifying unit 112 turns on a switch 116, so that power is supplied from an external power source El to the control unit 113 and an Input/output unit 114. In the case of the later described operation illustrated in FIG. 3, the power-supply command identifying unit 112 may be capable of Identifying only the power ON command for the television set.

Power is not supplied directly from the external power source E1 to the receiving unit 111 and the power-supply command identifying unit 112, but a very small amount of power is supplied from a primary cell, a secondary cell, a super capacitor, or the like. The power-supply command identifying unit 112 and the receiving unit 111 may be integrally formed as a chip.

The input/output unit 114 outputs HDMI-CEC (High Definition Multimedia Interface-Consumer Electronics Control) signals to another apparatus such as the other electronic apparatus (the DVD player), and receives HDMI signals (control signals, video signals, audio signals, and the like) input from another apparatus.

The control unit (a TV microcomputer) 113 identifies the remote control command received at the receiving unit 111 and signals that are input via the input/output unit 114, and, in accordance with the identification results, controls the entire television set 110 including a main unit 115, the input/output unit 114, and a switch 117. For example, in accordance with a control signal that is input from the DVD player 130 via the input/output unit 114, the control unit 113 switches the input destination of the input/output unit 114 to the DVD player 130, so that video signals from the DVD player 130 are supplied to the main unit 115.

Based on the video signals that are input from the DVD player 130 via the input/output unit 114, the main unit 115 provides main functions (main operations) such as displaying a video Image to users. The power from the external power source E1 is not supplied to the main unit 115 when the switch 117 is off, but is supplied when the switch 117 is on.

The ON/OFF control Is performed on the switch 117 in the following manner, for example. When the switch 116 is turned on to activate the control unit 113, the control unit 113 may automatically turn on the switch 117. Alternatively, when a power-supply ON signal is output from the receiving unit 111 or the power-supply command identifying unit 112, the switch 117 may be turned on. In that case, the receiving unit 111 or the power-supply command identifying unit 112 temporarily holds a power-supply command received from the remote controller 100 or holds a power-supply command beforehand, and, after the switch 116 is turned on, the power-supply command may be output to the control unit 113. When the power-supply command is output, the rise time of the control unit 113 Is taken into account. Therefore, the power-supply command may be output a predetermined period of standby time after the switch 116 is turned on. Alternatively, the control unit 113 may receive the power ON command for the television set from the DVD player 130 via the input/output unit 114. It should be noted that the control unit 113 is also capable of performing control by turning off the switch 116 to shut off the main power.

The set of the control unit 113, the input/output unit 114, the main unit 115, and the switch 117 forms an operating unit 119 of the present invention. The operating unit 119 operates in accordance with control performed on the other electronic apparatus (the DVD player 130).

A receiving unit 131 of the DVD player 130 receives the remote control command transmitted wirelessly or with infrared rays from the remote controller 100.

An input/output unit 134 outputs HDMI signals (control signals, video signals, audio signals, and the like) to the television set 110, and receives HDMI signals (control signals and the like) input from the television set 110. The input/output unit 134 and the input/output unit 114 are connected to each other by a cable 141 compliant with predetermined standards. The connection between the input/output unit 134 and the input/output unit 114 may be a wireless connection such as “Wireless HD.”

A main unit 133 performs main functions such as reproducing a video image based on a DVD.

A control unit 132 identifies the remote control command received at the receiving unit 131 and signals that are input via the input/output unit 134, and controls the entire DVD player 130 including the main unit 133 and the input/output unit 134. For example, based on the remote control command, the control unit 132 performs ON/OFF control on a switch 135 or reproduction control on the main unit 133.

The receiving unit 131, the control unit 132, and the input/output unit 134 are always connected to an external power source E2, and have power supplies. As the switch 135 is turned on and off, the power supply from the external power source E2 to the main unit 133 is switched on and off. When switch 135 is turned on, power is supplied to the main unit 133. When the switch 135 is turned off, the power supply to the main unit 133 is cut off.

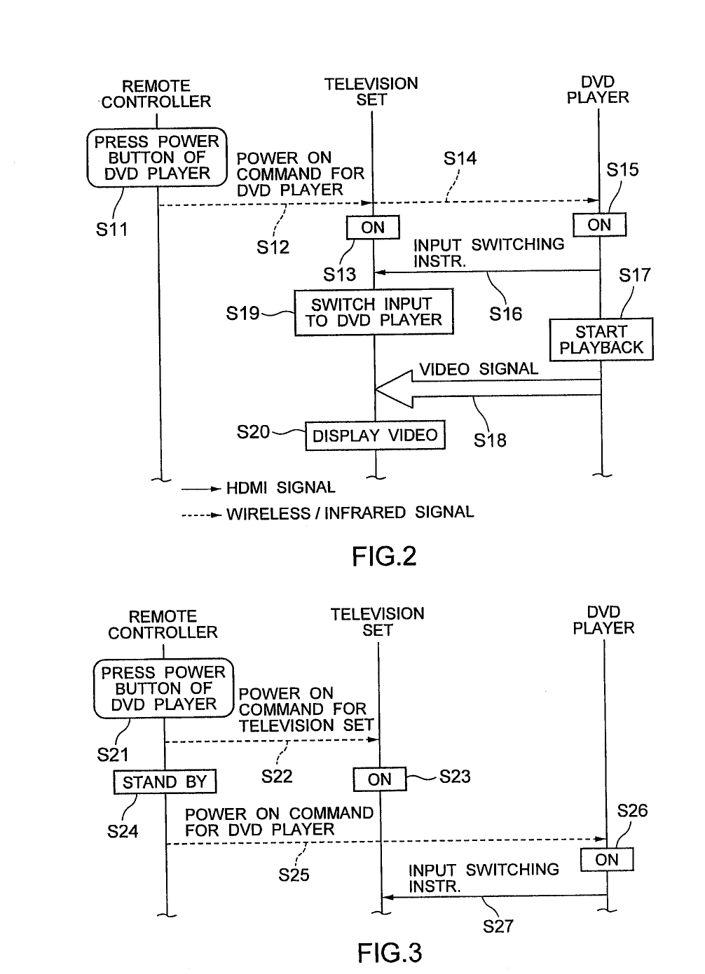

FIG. 2 shows an example of the flow of operations performed among the remote controller 100, the television set 110, and the DVD player 130. In the initial state, the switches 116 and 117 of the television set 110 are off, and power is not supplied to the control unit 113, the Input/output unit 114, and the main unit 115. Also, the switch 135 of the DVD player 130 Is off, and power Is not supplied to the main unit 133.

First, when a user performs an operation on the input unit 101 to switch on the DVD player 130 by pressing a power button of the remote controller 100, for example, the input unit 101 outputs the signal corresponding to the operation to the control unit 102 (S11).

Having receiving the signal from the input unit 101, the control unit 102 generates the power ON command for switching on the DVD player 130, and transmits the power ON command wirelessly or with infrared rays via the transmitting unit 103.

The receiving unit 131 of the DVD player 130 receives the power ON command for the DVD player (S14). Recognizing the reception of the power ON command, the control unit 132 turns on the switch 135, so that power is supplied from the external power source E2 to the main unit 133 (S15).

Meanwhile, the power ON command for the DVD player Is also received at the receiving unit 111 of the television set 110 (S12). Recognizing the reception of the power ON command, the power-supply command identifying unit 112 of the television set 110 turns on the switch 116, so that power is supplied from the external power source E1 to the control unit 113 and the input/output unit 114.

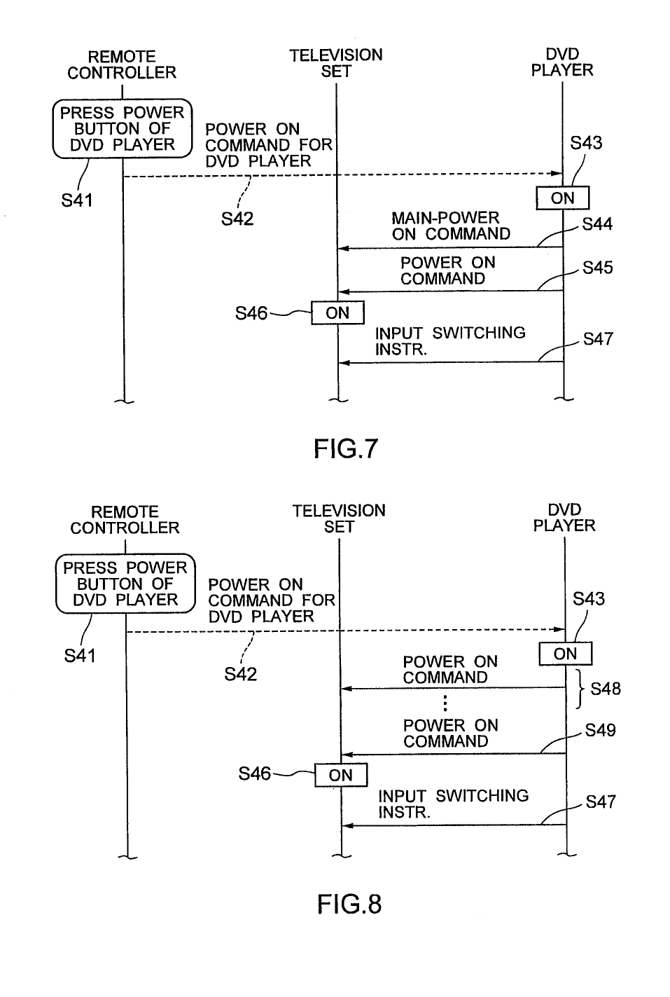

Here, (a) when the switch 116 is turned on to activate the control unit 113, the control unit 113 of the television set 110 may spontaneously turn on the switch 117, so that power is supplied to the main unit 115. (b) Alternatively, the power ON command for the television set or the like may be stored beforehand in the receiving unit 111 or the power-supply command identifying unit 112, and, after the switch 116 is turned on, the power ON command for the television set may be transmitted to the control unit 113. (c) The DVD player 130 that is switched on may transmit the power ON command to the control unit 113 via the input/output unit 134, so as to turn on the switch 117. In that case, the power ON command may be transmitted any time prior to the later described step S17 (a start of video image reproduction). Here, power is supplied to the main unit 115 through (a) or (b) (S13). As for the case of (c), please refer to FIGS. 7 and 8 described later.

Through the above operations, the power supplies to both the television set 110 and the DVD player 130 are switched on, and coordinated operations using HDMI between the television set 110 and the DVD player 130 are realized. To start the coordinated operations, the television set 110 needs power to be supplied to the control unit 113 and the input/output unit 114. However, the power supply to the main unit 115 is not necessary in starting the coordinated operations.

After that, the control unit 132 of the DVD player 130 transmits the control signal for switching the input to the DVD player 130, to the television set 110 via the input/output unit 134 (S16). It should be noted that, taking into account the rise time or the like of the control unit 113 of the television set 110, the control unit 132 of the DVD player 130 may transmit the switching control signal a predetermined period of standby time after the switch 135 is turned on (or after the power command is transmitted to the television set 110). After the switching control signal is transmitted, the main unit 133 of the DVD player 130 starts reproducing a video image (S17), and transmits a video signal to the television set 110 via the input/output unit 134 (S18).

Receiving the switching control signal via the input/output unit 114, the control unit 113 of the television set 110 switches the video input to the DVD player 130 (S19). Based on the video signal received from the DVD player 130 via the input/output unit 114, the main unit 115 displays a video image to the user (S20).

As described above, receiving a power ON command for the other electronic apparatus (a DVD player), the electronic apparatus (a television set) starts supplying power to the control unit and the input/output unit. Accordingly, the electronic apparatus can receive HDMI-CEC commands from the other electronic apparatus, and operate in coordination with the other electronic apparatus. Particularly, even in a situation where power is not supplied from the external power source E1 so as to minimize the standby power consumption of the television set, the following operations can be realized. When a user uses a remote controller to switch on the DVD player, the television set is automatically switched on, and receives power from the external power source E1. The input of the television set is then automatically switched to the DVD player by HDMI.

FIG. 3 shows another example of the flow of operations among the remote controller 100, the television set 110, and the DVD player 130. In the following, different operations from those in the sequence shown in FIG. 2 are mainly described.

When a user performs an operation on the input unit 101 to switch on the DVD player 130 (S21), the control unit 102 generates a power ON command for switching on the television set 110, and transmits the power ON command wirelessly or with infrared rays via the transmitting unit 103 (S22).

The power ON command transmitted from the remote controller 100 to the television set 110 is received by the receiving unit 111 of the television set 110. Recognizing the reception of the power ON command for the television set 110, the power-supply command identifying unit 112 turns on the switch 116, so that power is supplied from the external power source E1 to the control unit 113 and the input/output unit 114. Further, the control unit 113 turns on the switch 117 by the technique (a) or (b) described with reference to FIG. 2, so that power is supplied to the main unit 115 (S23).

Taking into account the rise time or the like of the control unit 113 of the television set 110, the control unit 102 of the remote controller 100 stands by for a predetermined period of time (S24) after the power ON command for the television set is transmitted. The control unit 102 then generates a power ON command for switching on the DVD player 130, and transmits the power ON command wirelessly or with infrared rays via the transmitting unit 103 (S25). The receiving unit 131 of the DVD player 130 receives the power command. Recognizing the reception of the power ON command, the control unit 132 turns on the switch 135, so that power is supplied from the external power source E2 to the main unit 133 (S26). The operations of step S27 and later are the same as those in the operations of step S16 and later shown in FIG. 2.

As described above, when a user performs an operation to switch on the other electronic apparatus (a DVD player) with the remote controller, the remote controller first transmits a power ON command for the electronic apparatus (a television set) to the television set, and transmits a power ON command for the other electronic apparatus (the DVD player) to the DVD player. Power is then supplied to the control unit (a TV microcomputer) and the input/output unit of the electronic apparatus (the television set), and accordingly, the electronic apparatus (the television set) can receive HDMI-CEC commands from the other electronic apparatus. Thus, operations can be performed in coordination with the other electronic apparatus, while the power consumption is minimized when the television set is not being used.

In the descriptions with reference to FIGS. 2 and 3, the power button for the DVD player 130 is pressed when a control Instruction is Input to the DVD player 130. However, the present invention is also effective in cases where some other control instruction is Input by pressing a play button or the like for the DVD player 130. For example, the switch 135 of the DVD player 130 may be turned on beforehand, and, when a user inputs a reproducing instruction to the remote controller 100, the remote controller 100 transmits a power ON command for the television set to the television set 110. After a predetermined period of standby time, the remote controller 100 transmits a reproducing command to the DVD player 130. In this manner, coordinated operations between the television set 110 and the DVD player 130 are also realized.

### Second Embodiment

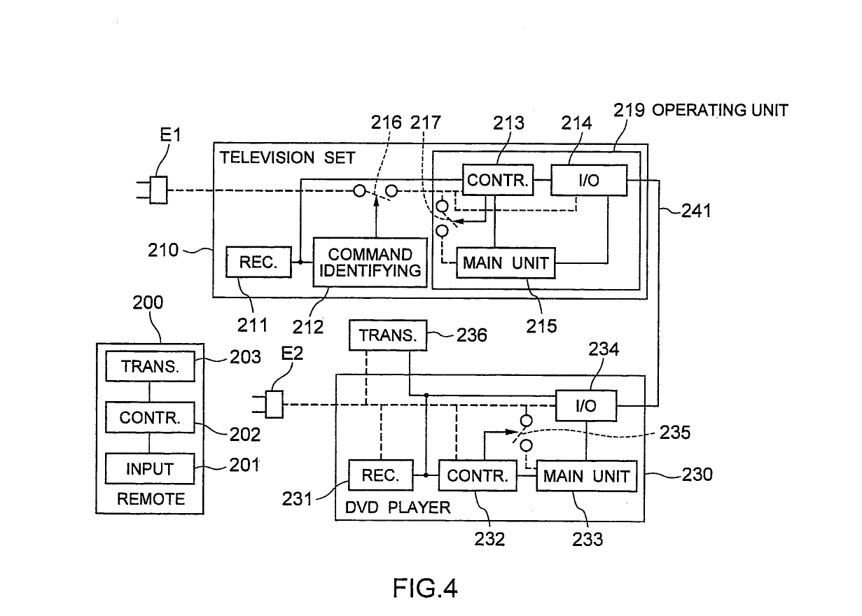

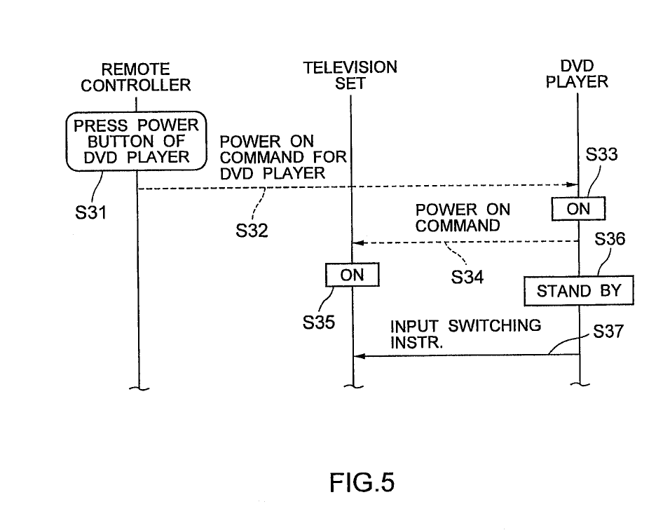

FIG. 4 shows an example structure of an entire electronic system according to a second embodiment that includes an electronic apparatus, another electronic apparatus, and a remote control device. The components in the respective apparatuses have the same functions as those of the components with the same names in the respective apparatuses shown in FIG. 1, unless otherwise specified. In the following, the differences from the first embodiment are mainly described.

A control unit 232 of a DVD player 230 generates or stores beforehand a power-supply command for a television set. In the latter case, a user may set a power-supply command for a television set in the DVD player 230. A transmitting unit 236 transmits the signal of the power-supply remote control command wirelessly or with Infrared rays. The user may set the transmitting unit 236 beforehand in a place from which a receiving unit 211 of a television set 210 can receive radio or infrared signals.

FIG. 5 shows an example of the flow of operations among a remote controller 200, the television set 210, and the DVD player 230 according to the second embodiment.

When a user performs an operation on the input unit 201 to switch on the DVD player 230 (S31), the control unit 202 generates a power ON command for switching on the DVD player 230, and transmits the power ON command wirelessly or with infrared rays via the transmitting unit 203 (S32).

The power ON command transmitted from the remote controller 200 to the DVD player 230 is received by a receiving unit 231 of the DVD player 230. Recognizing the reception of the power ON command, the control unit 232 turns on the switch 235, so that power is supplied from an external power source E2 to a main unit 233 (S33).

The control unit 232 then performs an operation to switch on the television set 210 connected to the DVD player 230 via an input/output unit 234. That is, the control unit 232 generates or reads a power ON command for the television set 210, and transmits the power ON command wirelessly of with infrared rays via the transmitting unit 236 (S34). The power ON command transmitted from the transmitting unit 236 to the television set 210 is received by the receiving unit 211 of the television set 210.

Recognizing that the signal received at the receiving unit 211 is a power ON command, the power-supply command identifying unit 212 of the television set 210 turns on a switch 216, so that power is supplied from an external power source E1 to a control unit 213 and an input/output unit 214. Further, the control unit 213 turns on a switch 217 by the above described technique (a) or (b) (S35).

After the transmission of the power ON command, the control unit 232 of the DVD player 230 stands by for a predetermined period of time, taking into account the rise time or the like of the control unit 213, of the television set 210 (S36). After that, the control unit 232 transmits a control signal to switch the input to the DVD player 230, to the television set 210 via the input/output unit 234 (S37). The operations to be performed thereafter are the same as those shown in FIG. 2 or 3.

As described above, when a user performs an operation to switch on the other electronic apparatus (a DVD player) with the remote controller or the like, the remote controller transmits a power ON command for the other electronic apparatus to the other electronic apparatus. Receiving the power ON command, the other electronic apparatus transmits a power ON command for a television set to the electronic apparatus (a television set) wirelessly or with infrared rays. Through the operation of the power-supply command identifying unit 212, the switch 216 is turned on, so that power from the external power source E1 is automatically supplied to the control unit (a TV microcomputer) and the input/output unit of the electronic apparatus (the television set). Accordingly, the electronic apparatus (the television set) can receive HDMI-CEC commands from the other electronic apparatus, and operate in coordination with the other electronic apparatus.

In a modification in which a user performs a DVD reproducing operation (inputs a control command) directly on the DVD player 230 while the DVD player 230 is on, the television set 210 can also be automatically switched on in the same manner as above. For example, a user inserts a DVD into the DVD player 230 and presses the play button of the main frame of the DVD player, or presses the DVD play button of the remote controller 200. In the latter case, the control unit 202 that receives a signal from the input unit 201 generates a remote control command for causing the DVD player 230 to start DVD reproduction, and transmits the remote control command via the transmitting unit 203. In the former case, the control unit 232 of the DVD player 230 recognizes the pressing of the play button of the main frame of the DVD player 230. In this manner, when a user sends an instruction to play a DVD, the control unit 232 of the DVD player 230 transmits a power ON command for a television set to the television set 210 via the transmitting unit 236. The power ON command for a television set is received by the receiving unit 211 of the television set 210. Recognizing the reception of the power ON command, the power-supply command identifying unit 212 of the television set 210 turns on the switch 216, so that power is supplied from the external power source E1 to the control unit 213 and the input/output unit 214. The operations to be performed thereafter are the same as those of S36 and later shown in FIG. 5.

By virtue of the above described operations, when a user performs a DVD reproduction starting operation or the like on the other electronic apparatus (a DVD player) even in a situation where the standby power consumption of the electronic apparatus (a television set) is minimized by turning off an AC switch or the like, the other electronic apparatus transmits the power ON command to the electronic apparatus (the television set) wirelessly or with infrared rays, and power is automatically supplied to the control unit and the like of the electronic apparatus (the television set). Accordingly, the electronic apparatus (the television set) can receive HDMI signals from the other electronic apparatus (the DVD player), and thereby realize operation in coordination with the other electronic apparatus (the DVD player).

### Third Embodiment

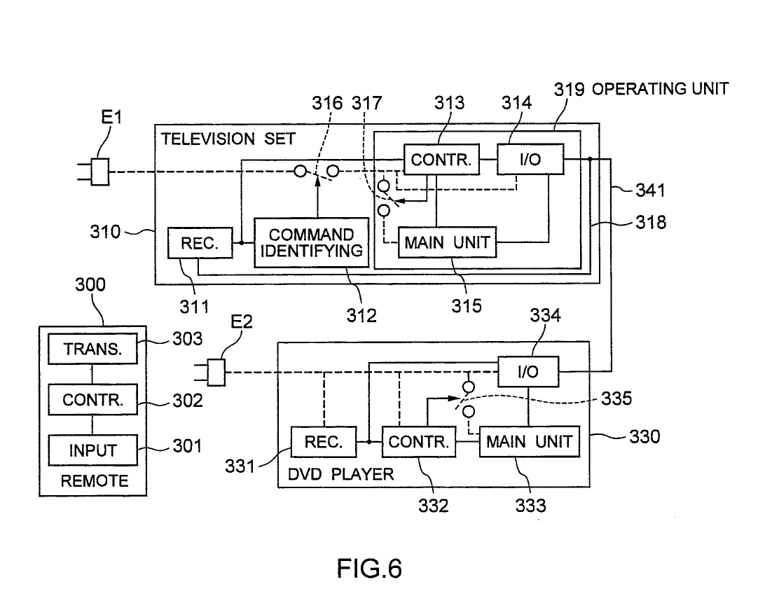

FIG. 6 shows an example structure of an entire electronic system according to a third embodiment that includes an electronic apparatus, another electronic apparatus, and a remote control device. The components in the respective apparatuses have the same functions as those of the components with the same names in the respective apparatuses shown in FIG. 1, unless otherwise specified. In the following, the differences from the first embodiment are mainly described.

A receiving unit 311 of a television set 310 is connected to a connecting cable 341 between an input/output unit 334 of a DVD player 330 and an input/output unit 314 of the television set 310 via a signal line 318. The receiving unit 311 is designed to be capable of receiving output signals from the input/output unit 334 of the DVD player 330 via the signal line 318. Accordingly, the output signals from the DVD player 330 are input to the input/output unit 314 and the receiving unit 311 of the television set 310.

FIG. 7 shows an example of the flow of operations among a remote controller 300, the television set 310, and the DVD player 330 according to the third embodiment.

When a user performs an operation on the input unit 301 of the remote controller 300 to switch on the DVD player 330 (S41), the control unit 302 generates a power ON command for switching on the DVD player 330, and transmits the power ON command wirelessly or with infrared rays via the transmitting unit 303 (S42).

The power ON command transmitted from the remote controller 300 to the DVD player 330 is received by a receiving unit 331 of the DVD player 330. Recognizing the reception of the power ON command, a control unit 332 turns on a switch 335, so that power is supplied from an external power source E2 to a main unit 333 (S43).

The control unit 332 then performs an operation to switch on the television set 310 connected to the DVD player 330 via the input/output unit 334. First, the control unit 332 generates a main-power ON command for the television set 310 (a command to turn on only a switch 316), and transmits the main-power ON command via the input/output unit 334 (S44). The main-power ON command may be set beforehand in the DVD player 330 by a user. For example, in a case where a rectifier is used as the receiving unit 311 of the television set 310, the main-power ON command may be generated by a simple modulation signal such as an OOK (On-Off Keying) signal or a PPM (Pulse Position Modulation) signal.

The main-power ON command transmitted from the input/output unit 334 to the television set 310 is received by the receiving unit 311 of the television set 310 via the input/output unit 314, the signal line 318, and the like. Recognizing that the signal received by the receiving unit 311 is a main-power ON command, a power-supply command identifying unit 312 turns on the switch 316, so that power is supplied from an external power source E1 to a control unit 313 and the input/output unit 314. The control unit 332 of the DVD player 330 then transmits a power ON command for the television set 310 (a command to turn on a switch 317 in this case) via the input/output unit 334 (S45). This power ON command is supplied to the control unit 313 via the input/output unit 314 of the television set 310. The control unit 313 turns on the switch 317, so that power is supplied from the external power source E1 to the main unit 315 (S46). Steps S45 and S46 are equivalent to the above described case (c). It should be noted that the power ON command may be identified by the power-supply command identifying unit 312, and be transmitted to the control unit 313 via the power-supply command Identifying unit 312. The operations of step S47 and later are the same as those of step S16 and later shown in FIG. 2.

FIG. 7 shows an example case where the main-power ON command (a specific command) for turning on the switch 316 Is defined and used. In an example case shown in FIG. 8, on the other hand, the control unit 332 transmits a power ON command two or more times (S48), for example. When the rectifier of the receiving unit 311 senses signals that meet standards (such as continuous inputs of voltage level signals equal to or higher than a threshold value for a certain period of time, or inputs of signals having a predetermined pattern) that are set beforehand, the power-supply command identifying unit 312 of the television set 310 may turn on the switch 316. Signals to be transmitted can be arbitrarily set in accordance with the above mentioned standards. As signals of a power-supply command are used in this case, there is no need to register a new signal In the DVD player 330. After transmitting a power ON command two or more times, the control unit 332 stands by for a predetermined period of time, taking into account the rise time of the control unit 313. The control unit 332 then further transmits a power ON command (S49). This power ON command is received by the control unit 313 via the input/output unit 314, and the control unit 313 turns on the switch 317. Alternatively, power ON commands received after the switch 316 is turned on may be transferred to the control unit 313 by the receiving unit 311 or the power-supply command identifying unit 312.

As described above with reference to FIG. 7 or 8, when a user performs an operation to switch on the other electronic apparatus (a DVD player) with a remote controller or the like, the remote controller transmits a power ON command for the other electronic apparatus. Receiving the power ON command, the other electronic apparatus transmits a main-power ON command or a power ON command string to the electronic apparatus (a television set) via a HDMI interface or the like. The receiving unit of the television set receives the main-power ON command or the power ON command string. The power-supply command identifying unit 312 then turns on the switch 316, so that power is supplied to the control unit and the input/output unit of the electronic apparatus (the television set). In this manner, coordinated operations between the electronic apparatus and the other electronic apparatus become possible. For example, the electronic apparatus (the television set) may receive a power ON command from the other electronic apparatus (a video reproducing apparatus) (S45 or 49), so that power from the external power source E1 can be supplied to the main unit 315.

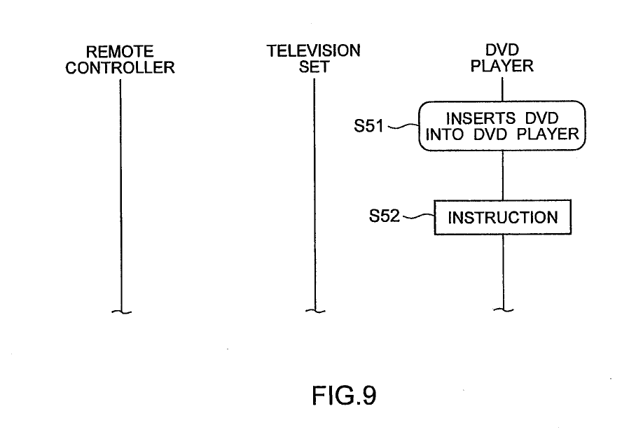

As shown in FIG. 9, a user inserts a DVD into the DVD player 330 (S51) while the DVD player 330 is on, and the user operates the DVD player 330 to play the DVD (S52), as in the second embodiment. In that case, the operation to automatically switch on the television set 310 can also be performed. The sequence thereafter is the same as that of step S44 and later shown in FIG. 7.

As described above, when a user sends a DVD reproducing instruction, the other electronic apparatus transmits a main-power ON command or a power ON command string to the electronic apparatus (a television set). The power-supply command identifying unit 312 turns on the switch 316, so that power is supplied to the control unit 313 of the electronic apparatus (the television set). In this manner, coordinated operations between the electronic apparatus and the other electronic apparatus become possible. For example, by receiving a power ON command from the other electronic apparatus, the electronic apparatus (the television set) can supply power from the external power source E1 to the main unit 315.

### Fourth Embodiment

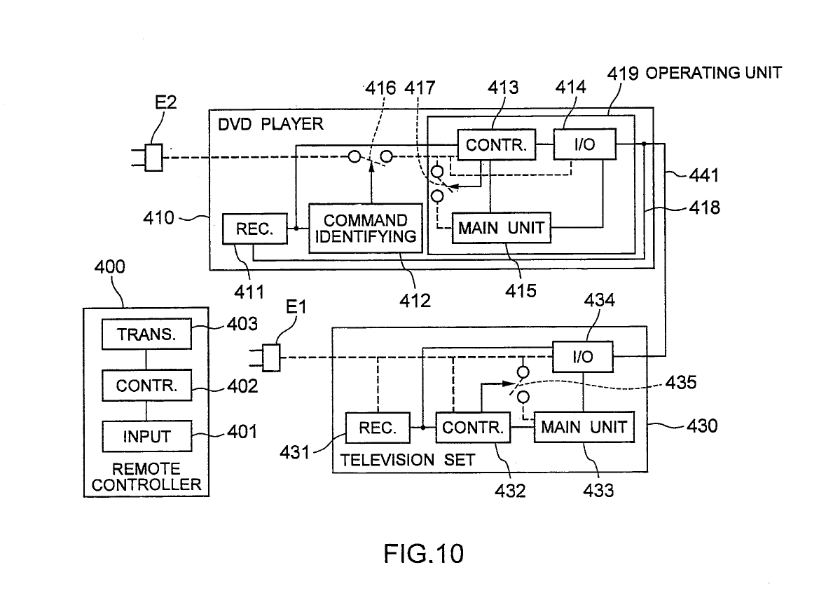

FIG. 10 shows an example structure of an entire electronic system according to a fourth embodiment that includes an electronic apparatus, another electronic apparatus, and a remote control device.

This embodiment shows an example case where the remote control device is a remote controller 400, the electronic apparatus is a DVD player 410, and the other electronic apparatus is a television set 430. The components in the respective apparatuses are substantially the same as those shown in FIG. 6. However, this embodiment greatly differs from the third embodiment in that the function of the television set and the function of the DVD player are switched in terms of structures and operations to realize coordinated operations between the apparatuses. In the following, the differences from the third embodiment (FIGS. 6 and 7) are mainly described, and the same components as those of the third embodiment are not described or are only briefly described. It should be noted that the television set 430 may have the same structure as that of any of the first through third embodiments.

A receiving unit 411 of the DVD player 410 receives a remote control command transmitted wirelessly or with infrared rays from the remote controller 400. A rectifier, for example, may be used as the receiving unit 411, to minimize the standby power consumption. A power-supply command identifying unit 412 determines whether the remote control command received by the receiving unit 411 is a main-power ON command or a power ON command, and turns on and off a switch 416. Power is not supplied from outside to the receiving unit 411 and the power-supply command identifying unit 412, but a very small amount of power is supplied from a primary cell, a secondary cell, a super capacitor, or the like, to the receiving unit 411 and the power-supply command identifying unit 412. A control unit 413 identifies the remote control command received by the receiving unit 411 and signals that are input via an input/output unit 414. The control unit 413 performs ON/OFF control on a switch 417, and also controls a main unit 415, the input/output unit 414, and the like. The input/output unit 414 outputs HDMI signals to another apparatus, and receives HDMI signals from another apparatus. The input/output unit 414 also transmits control signals generated for the television set 430 or the like by the control unit 413, and receives control signals from the television set 430. The main unit 415 provides a main function such as playing a DVD. The receiving unit 411 is connected to a connecting cable 441 between the input/output unit 414 of the DVD player 410 and an input/output unit 434 of the television set 430 via a signal line 418. The receiving unit 411 receives output signals from the input/output unit 414 of the DVD player 410 via the signal line 418. The set of the control unit 413, the input/output unit 414, the main unit 415, and the switch 417 forms an operating unit 419.

A receiving unit 431 of the television set 430 receives the remote control command transmitted wirelessly or with infrared rays from the remote controller 400. A control unit 432 identifies the remote control command received by the receiving unit 431, and signals that are input via the input/output unit 434. The control unit 432 performs ON/OFF control on a switch 435, and controls a main unit 433, the input/output unit 434, and the like. The main unit 433 provides a main function such as outputting a video image to a user.

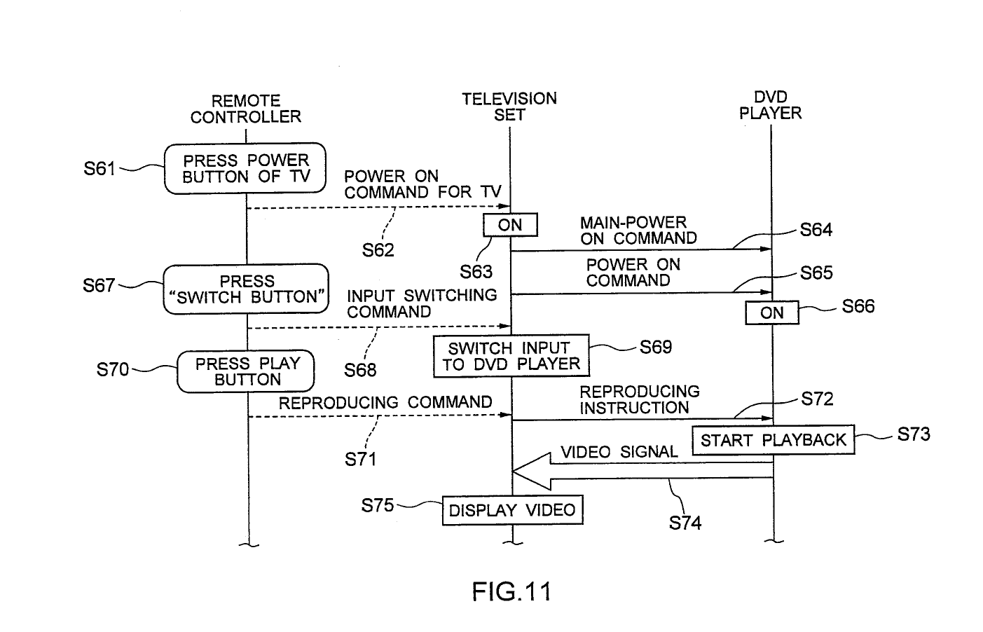

FIG. 11 shows an example of the flow of operations among the remote controller 400, the DVD player 410, and the television set 430 according to the fourth embodiment. In the initial state, the switches 416 and 417 of the DVD player 410 are off, and power is not supplied to the control unit 413, the input/output unit 414, and the main unit 415.

First, a user performs an operation on the input unit 401 to switch on the DVD player 410 by pressing a power button of the remote controller 400, for example (S61). The control unit 402 generates a power ON command for switching on the television set 430, and transmits the power ON command wirelessly or with infrared rays via the transmitting unit 403 (S62).

The power ON command transmitted from the remote controller 400 to the television set 430 is received by the receiving unit 431 of the television set 430. Recognizing the reception of the power ON command, the control unit 432 turns on the switch 435, so that power is supplied from an external power source E1 to the main unit 433 (S63).

The control unit 432 then performs an operation to switch on the DVD player 410 connected to the television set 430 via the input/output unit 434. The control unit 432 generates a main-power ON command for the DVD player 410, and transmits the main-power ON command via the input/output unit 434 (S64). The method of setting and defining the main-power ON command are the same as that of the third embodiment. The main-power ON command transmitted from the input/output unit 434 to the DVD player 410 Is received by the receiving unit 411 of the DVD player 410 via the input/output unit 414, the signal line 418, and the like. Recognizing that the received signal indicates a main-power ON command, the power-supply command identifying unit 412 turns on the switch 416, so that power is supplied from an external power source E2 to the control unit 413 and the input/output unit 414. After that, the control unit 432 further transmits a power ON command via the input/output unit 434 (S65). This power ON command is received by the control unit 413, and the control unit 413 turns on the switch 417 (S66). Prior to the transmission of the power ON command, the control unit 432 of the television set 430 may stand by for a predetermined period of time after the transmission of the main-power ON command in step S64, taking into account the rise time or the like of the control unit 413 of the DVD player 410.

Note that, as in the third embodiment, a power ON command may be transmitted two or more times (or an arbitrary signal string may be transmitted), instead of the main-power ON command. In a case where the television set 430 transmits a power ON command two or more times, the receiving unit 411 of the DVD player 410 receives the power ON command two or more times. Recognizing the reception of a signal that meets predetermined standards via the receiving unit 411, the power-supply command identifying unit 412 turns on the switch 416, so that power is supplied from the external power source E2 to the control unit 413 and the input/output unit 414. After that, when a power ON command is received (S65), the switch 417 is turned on (S66).

Subsequently receiving an input switching command (S68) in response to a user pressing a button (S67), the control unit 432 of the television set 430 switches its input to the DVD player 410 (S69). Further, receiving a reproducing command (S71) in response to a user pressing a button (S70), the control unit 432 of the television set 430 transmits a control signal indicative of a reproducing instruction to the DVD player 410 (S72), and the reproduction instructing signal is input to the control unit 413 of the DVD player 410. The main unit 415 starts reproducing a video image (S73), and transmits a video signal to the television set 430 via the input/output unit 434 (S74). Based on the video signal received via the input/output unit 434, the main unit 433 displays the video image to the user (S75).

As described above, when a user performs an operation to switch on the other electronic apparatus (a television set) with a remote controller or the like, the remote controller transmits a power ON command for the other electronic apparatus (the television set). The other electronic apparatus (the television set) that receives the power ON command transmits a main-power ON command (or transmits a power ON command two or more times) to the electronic apparatus (a DVD player), so that power is supplied to the control unit 413 of the electronic apparatus. Accordingly, the electronic apparatus can receive HDMI-CEC commands from the other electronic apparatus, and operate in coordination with the other electronic apparatus.

### Fifth Embodiment

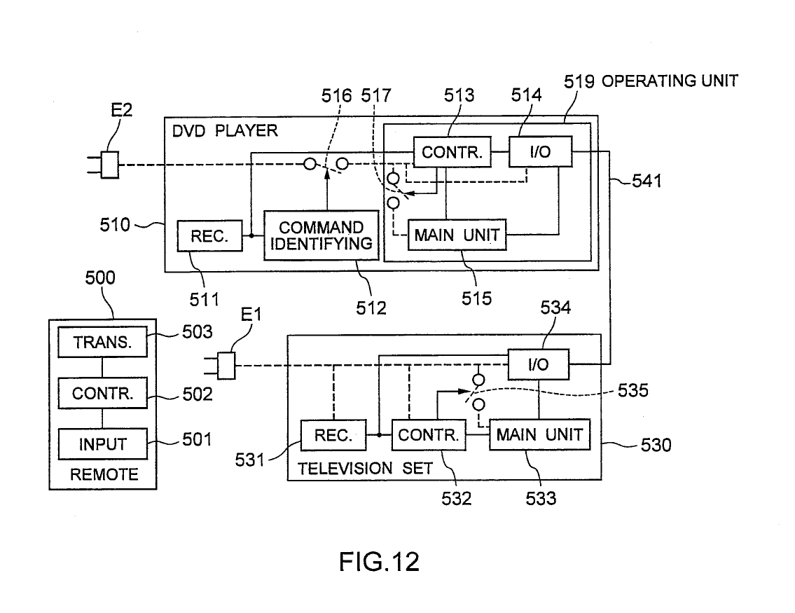

FIG. 12 shows an example structure of an entire electronic system according to a fifth embodiment that includes an electronic apparatus, another electronic apparatus, and a remote control device. The components in the respective apparatuses have the same functions as those of the components with the same names in the respective apparatuses shown in FIG. 10, unless otherwise specified. In the following, the differences from the fourth embodiment are mainly described.

In this embodiment, a receiving unit 511 is not connected to a connecting cable 541, and output signals from an input/output unit 534 are not input to the receiving unit 511. A power ON command for a television set 530 is set beforehand in a DVD player 510, so that the power ON command can be identified by a power-supply command identifying unit 512.

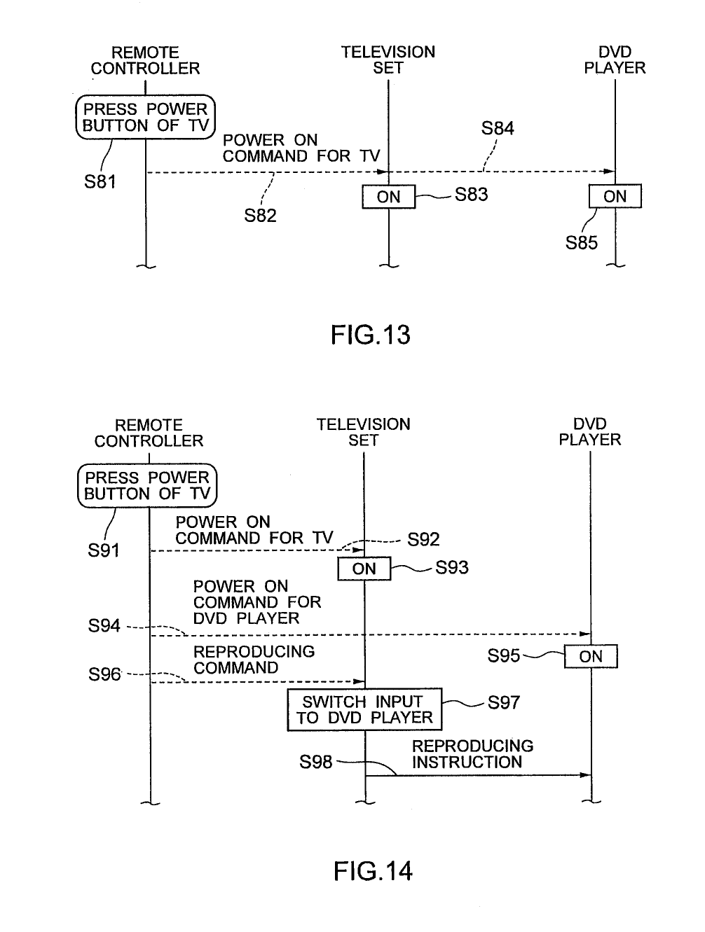

FIG. 13 shows an example of the flow of operations among a remote controller 500, the DVD player 510, and the television set 530 according to the fifth embodiment. In the initial state, switches 516 and 517 of the DVD player 510 are off, and power is not supplied to a control unit 513, an input/output unit 514, and a main unit 515.

First, a user performs an operation on an input unit 501 to switch on the television set 530 by pressing a power button of the remote controller 500, for example (S81). A control unit 502 generates a power ON command for switching on the television set 530, and transmits the power ON command wirelessly or with infrared rays via a transmitting unit 503 (S82).

The power ON command is received by a receiving unit 531 of the television set 530. Recognizing the reception of the power ON command, a control unit 532 turns on a switch 535, so that power is supplied from an external power source E1 to a main unit 533 (S83).

The power ON command transmitted from the remote controller 500 to the television set 530 is also received by the receiving unit 511 of the DVD player 510 (S84). Recognizing the reception of the power ON command for the television set 530, the power-supply command identifying unit 512 turns on the switch 516, so that power is supplied from an external power source E2 to the control unit 513 and the input/output unit 514. Further, the control unit 513 turns on the switch 517 by one of the techniques (a) through (c) described in the first embodiment, so that power is supplied from the external power source E2 to the main unit 515 (585).

In this manner, coordinated operations using HDMI between the DVD player 510 and the television set 530 are enabled. The operations to be performed thereafter are the same as those of step S67 and later in the sequence shown in FIG. 11, and therefore, explanation of them is omitted herein.

As described above, when a user performs an operation to switch on the other electronic apparatus (a television set) with a remote controller, the remote controller transmits a power ON command for the other electronic apparatus (the television set). The power ON command is also received by the electronic apparatus (a DVD player), so that power is also supplied to the control unit (a microcomputer) and the input/output unit of the electronic apparatus. Accordingly, the electronic apparatus (the DVD player) can receive HDMI-CEC commands from the other electronic apparatus (the television set), and coordinated operations such as remote control pass-through between the electronic apparatus and the other electronic apparatus become possible.

FIG. 14 shows another example of the flow of operations among the remote controller 500, the DVD player 510, and the television set 530 according to the fifth embodiment.

First, a user performs an operation on the input unit 501 to switch on the television set 530 (S91). The control unit 502 generates a power ON command for switching on the television set 530, and transmits the power ON command wirelessly or with infrared rays via the transmitting unit 503 (S92).

The power ON command transmitted from the remote controller 500 to the television set 530 is received by the receiving unit 531 of the television set 530 (S92). Recognizing the reception of the power ON command to the television set 530 itself, the control unit 532 turns on the switch 535, so that power is supplied from the external power source E1 to the main unit 533 (S93).

The control unit 502 of the remote controller 500 then generates a power ON command for switching on the DVD player 510, and transmits the power ON command wirelessly or with infrared rays via the transmitting unit 503 (S94). The receiving unit 511 of the DVD player 510 receives the power command. Recognizing the reception of the power ON command, the power-supply command identifying unit 512 turns on the switch 516, so that power from the external power source E2 is supplied to the control unit 513 and the input/output unit 514 (S95).

Through the above operations, power is supplied from outside to both the television set 530 and the DVD player 510, and coordinated operations using HDMI between the television set 530 and the DVD player 510 are realized.

For example, receiving a reproducing command from the remote controller 500 (S96), the control unit 532 of the television set 530 automatically switches its input to the DVD player 510 (S97), and issues a DVD reproducing instruction to the DVD player 510 via the input/output unit 534 (S98). After transmitting the power command in step S94, the remote controller 500 may stand by for a predetermined period of time, and then automatically transmit the reproducing command. Alternatively, the remote controller 500 may transmit the reproducing command, using a user input as a trigger. The operations to be performed thereafter are the same as those of step S73 and later shown in FIG. 11.

As described above, when a user presses a power-on button of the remote control device that controls mainly the other electronic apparatus (a television set), the remote control device transmits a power ON command to the other electronic apparatus (the television set), and also transmits a power ON command to the electronic apparatus (a DVD player). In response to the command transmission to the electronic apparatus, the power-supply command identifying unit 512 of the electronic apparatus turns on the switch 516. As a result of this, power is supplied to the control unit (a microcomputer) and the input/output unit of the electronic apparatus. Accordingly, the electronic apparatus (the DVD player) can receive HDMI-CEC commands from the other electronic apparatus (the television set), and coordinated operations such as remote control pass-through between the electronic apparatus (the DVD player) and the other electronic apparatus (the television set) become possible.

Note that in the first through fifth embodiments, coordinated operations between a television set and a DVD player have been described as examples. However, the present invention can be widely applied to coordinated operations between any output apparatus such as a display apparatus and any apparatus that Is used in combination with the output apparatus. For example, the present invention can be applied to coordinated operations In a combination of a television set and a DVD recorder, a combination of a television set and an apparatus with a HDD built-in, a combination of a television set and a PC (Personal Computer), a combination of a television set and a game machine, and a combination of a speaker and an AV amplifier.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

1. An electronic apparatus which operates under another electronic apparatus when the other electronic apparatus is controlled by a predetermined control instruction, comprising:
a receiving unit configured to receive a power ON command;
a microcomputer configured to operate under control of the other electronic apparatus;
a switch configured to switch whether to supply power from an external power source to the microcomputer; and
a power control unit configured to turn on the switch when the receiving unit receives the power ON command so that the microcomputer can be controlled by the other electronic apparatus.

2. The apparatus according to claim 1, wherein the receiving unit receives the power ON command from the other electronic apparatus.

3. The apparatus according to claim 2, wherein the receiving unit receives the power ON command from a remote control device that controls the other electronic apparatus.

4. An electronic system comprising:
the electronic apparatus according to claim 1; and
a remote control device for the other electronic apparatus, wherein
the remote control device includes an input unit that receives a control instruction for the other electronic apparatus from a user,
the remote control device transmits, when the control instruction is input to the input unit, the power ON command to the electronic apparatus and transmits a command corresponding to contents of the control instruction to the other electronic apparatus.

5. The apparatus according to claim 1, further comprising:
a main unit configured to provide a main function; and
another switch configured to switch whether to supply the power to the main unit,
wherein the microcomputer supplied with the power turns on the other switch to supply the power to the main unit.

6. The apparatus according to claim 2, wherein the receiving unit receives the power ON command wirelessly or with infrared rays from the other electronic apparatus.

7. The apparatus according to claim 1, wherein the receiving unit and the power control unit operate with power from a primary cell, a secondary cell, or a super capacitor, the power from the external power source being different from the power from the primary cell, the secondary cell, or the super capacitor.

8. An electronic system comprising:
the electronic apparatus according to claim 1,
the other electronic apparatus according to claim 1, and
a remote control device, wherein
the other electronic apparatus includes:
a first receiving unit configured to receive the power ON command;
a first switch configured to switch whether to supply power from a first external power source to the first main unit;
a first main unit configured to provide a main function; and
a first microcomputer configured to receive a supply of the power from the first external power source to operate, and turn on the first switch when the first receiving unit receives the power ON command,
the remote control device transmits the power ON command to each of the electronic apparatus and the other electronic apparatus.

9. The system according to claim 8, wherein the remote control device receives a control instruction or a power-on instruction for the other electronic apparatus, and transmits the power ON command to each of the electronic apparatus and the other electronic apparatus when the control instruction or the power-on instruction is Input to the remote control device.

10. The system according to claim 9, wherein the remote control device first transmits the power ON command to the electronic apparatus, and transmits the power ON command to the other electronic apparatus a predetermined period of time after the transmission of the power ON command to the electronic apparatus, the predetermined period of time being determined in accordance with a rise time of the microcomputer of the electronic apparatus.

11. The system according to claim 8, wherein
the electronic apparatus includes:
a main unit configured to provide a main function; and
another switch configured to switch whether to supply the power from the external power source to the main unit,
wherein the microcomputer supplied with the power turns on the other switch.
